(19) United States
(12) Patent Application Publication
(10) Pub. No.: US 2015/0149169 A1
(43) Pub. Date: May 28, 2015

(54) METHOD AND APPARATUS FOR PROVIDING MOBILE MULTIMODAL SPEECH HEARING AID

(71) Applicant: AT&T Intellectual Property I, L.P., Atlanta, GA (US)

(72) Inventor: Hisao M. Chang, Cedar Park, TX (US)

(73) Assignee: AT&T Intellectual Property I, L.P., Atlanta, GA (US)

(21) Appl. No.: 14/092,834

(22) Filed: Nov. 27, 2013

(51) Int. Cl. G10L 15/26

(52) U.S. Cl. CPC G10L 15/26
USPC 704/235

(57) ABSTRACT

A method, computer-readable storage device and apparatus for processing an utterance are disclosed. For example, the method captures the utterance made by a speaker, captures a video of the speaker making the utterance, sends the utterance and the video to a speech to text transcription device, receives a text representing the utterance from the speech to text transcription device, wherein the text is presented on a screen of a mobile endpoint device, and sends the utterance to a hearing aid device.

### BACKGROUND

The wearable hearing aid device is traditionally based on a customized hardware device that the hearing impaired persons wear around their ears. Because hearing loss is highly personal, all traditional hearing aid devices require special adjustment (or “tuning”) from time to time by a trained professional in order to achieve a desired performance. This manual tuning process is slow, expensive, and often inconvenient to senior users who have difficulty travelling to an office of a doctor, an audiologist or a hearing aid specialist.

### SUMMARY

In one embodiment, the present disclosure provides a method, computer-readable storage device, and apparatus for processing an utterance. For example, the method captures the utterance made by a speaker, captures a video of the speaker making the utterance, sends the utterance and the video to a speech to text transcription device, receives a text representing the utterance from the speech to text transcription device, wherein the text is presented on a screen of a mobile endpoint device, and sends the utterance to a hearing aid device.

### BRIEF DESCRIPTION OF THE DRAWINGS

The essence of the present disclosure can be readily understood by considering the following detailed description in conjunction with the accompanying drawings, in which:

FIG. 1 illustrates one example of a communication network of the present disclosure;

FIG. 2 illustrates a mobile multimodal speech hearing aid system;

FIG. 3 illustrates an example flowchart of a method for providing mobile multimodal speech hearing aid;

FIG. 4 illustrates yet another example flowchart of a method for providing mobile multimodal speech hearing aid; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, a computer-readable storage device and an apparatus for providing mobile multimodal speech hearing aid. As noted above, hearing aid devices require special adjustment (or “tuning”) from time to time in order to achieve a desired performance. For example, a user of one or more hearing aid devices may gradually suffer additional hearing degradation. To address such changes, the user must seek the help of a hearing aid specialist to tune the one or more hearing aid devices.

Hearing aid devices are often calibrated using pre-calculations of numerous parameters that are intended to provide the most ideal setting for the general public. Unfortunately, pre-calculated target-amplification does not always meet the desired loudness and sound impression for individual hearing impaired. Thus, an audiologist will often conduct various audio tests and then fine tune the hearing aid devices to be tailored to a particular hearing impaired. The parameters that can be adjusted may comprise: volume, pitch, frequency range, and noise filtering parameters. These are only a few examples of the various tunable parameters for the hearing aid devices.

Furthermore, the various tunable parameters are “statically” tuned. In other words, the tuning occurs in the office of the audiologist where certain baseline inputs are used in the tuning. Once the hearing aid devices are tuned, these various tunable parameters are not adjusted until the next manual tuning session. Of course, the hearing impaired may also have the ability to tune certain tunable parameters at a home location. In other words, certain tunable parameters can be manually adjusted by the individual hearing impaired, e.g., a remote control can be provided to the hearing impaired.

In one embodiment, the present disclosure provides a method for dynamically tuning the hearing aid devices. In another embodiment, the present disclosure provides a method for providing a multimodal hearing aid, e.g., an audio aid in conjunction with a visual aid.

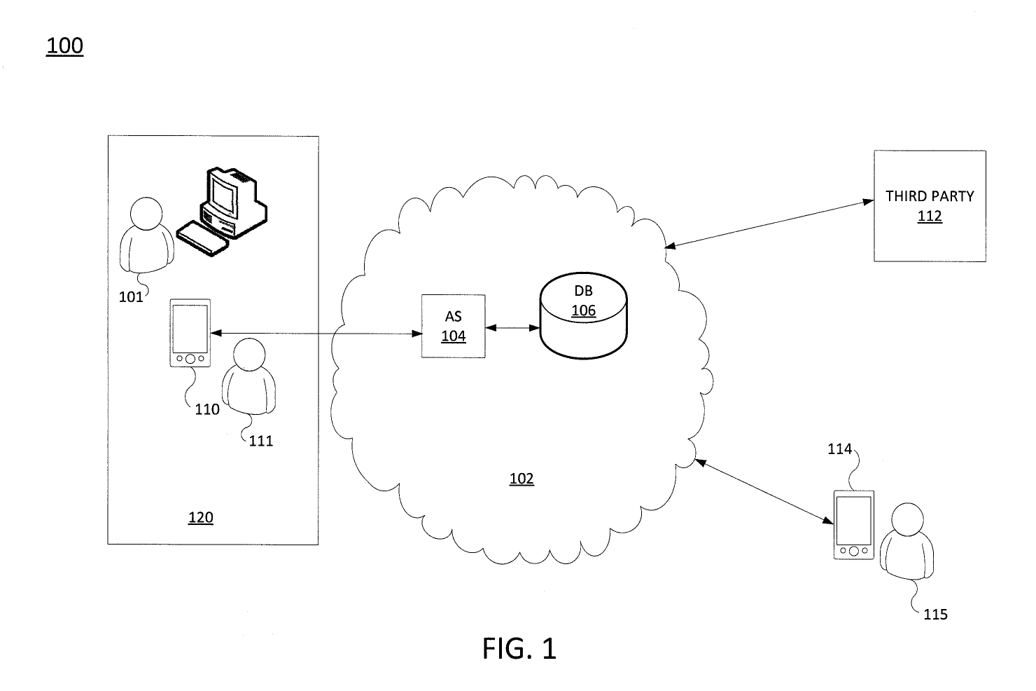

FIG. 1 is a block diagram depicting one example of a communications network 100. For example, the communication network 100 may be any type of communications network, such as for example, a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and the like related to the current disclosure. It should be noted that an IP network is broadly defined as a network that uses Internet Protocol to exchange data packets.

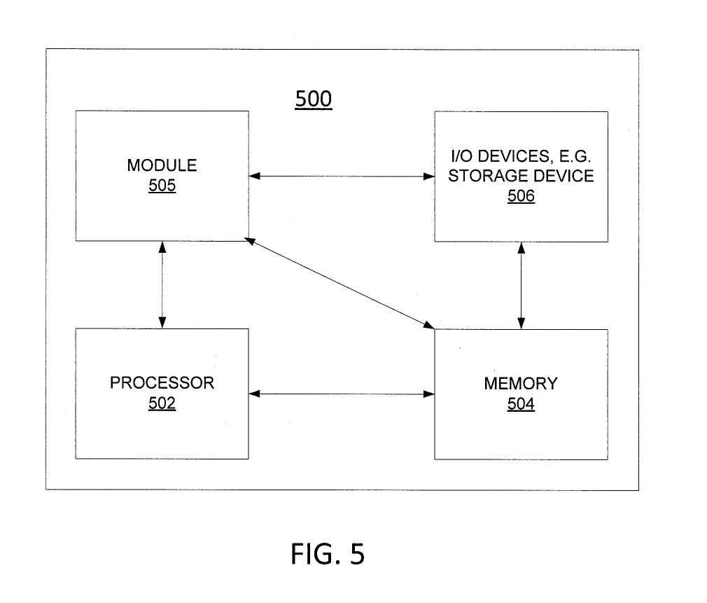

In one embodiment, the communications network 100 may include a core network 102. The core network 102 may include an application server (AS) 104 and a database (DB) 106. The AS 104 may be deployed as a hardware device embodied as a general purpose computer (e.g., the general purpose computer 500 illustrated in FIG. 5). In one embodiment, the AS 104 may perform the methods and functions described herein (e.g., the method 400 discussed below).

In one embodiment, the DB 106 may store various user profiles and various speech context models. The user profiles and speech context models are discussed below. The DB 106 may also store all subscriber information and mobile endpoint telephone number(s) of each subscriber.

In one embodiment, the communications network may include one or more access networks (e.g., a cellular network, a wireless network, a wireless fidelity (Wi-Fi) network, a PSTN network, an IP network, and the like) that are not shown to simply FIG. 1. In one embodiment, the communications network 100 in FIG. is simplified and it should be noted the communications network 100 may also include additional network elements (not shown), such as for example, border elements, gateways, firewalls, routers, switches, call control elements, various application servers, and the like.

In one embodiment, a user 111 using a mobile endpoint device 110 may be communicating with a speaker 101 in an environment 120 such as a doctor office, a work office, a home, a library, a classroom, a public area, and the like. In one embodiment, the user 111 is using the mobile endpoint device 110 that is running an application that provides dynamic hearing aid tuning and/or multimodal hearing aid. The mobile endpoint device 110 may be any type of mobile endpoint device, e.g., a cellular telephone, a smart phone, a tablet computer, and the like. In one embodiment, the mobile endpoint device 110 has a camera that has video capturing capability.

In one embodiment, the third party 112, e.g., a server or a web server, may be in communication with the core network 102 and the AS 104. The third party server may be operated by a health care provider such as an audiologist or a manufacturer of a hearing aid device. In one embodiment, the third party server may provide services such as hearing aid tuning algorithms or analysis of hearing aid adjustments that were made on a hearing aid device operated by the user 111. In one embodiment, the user 111 may be communicating with another user 115 operating an endpoint device 114. For example, user 111 may be using a “face chat” application to communicate with user 115. In one embodiment, the face chat session can be recorded and the mobile multimodal speech hearing aid method as discussed below can be applied to the stored face chat session.

It should be noted that although a single third party 112 is illustrated in FIG. 1, any number of third party websites may be deployed. In addition, although only two mobile endpoint devices 110 and 114 are deployed, any number of endpoint devices and mobile endpoint devices may be deployed.

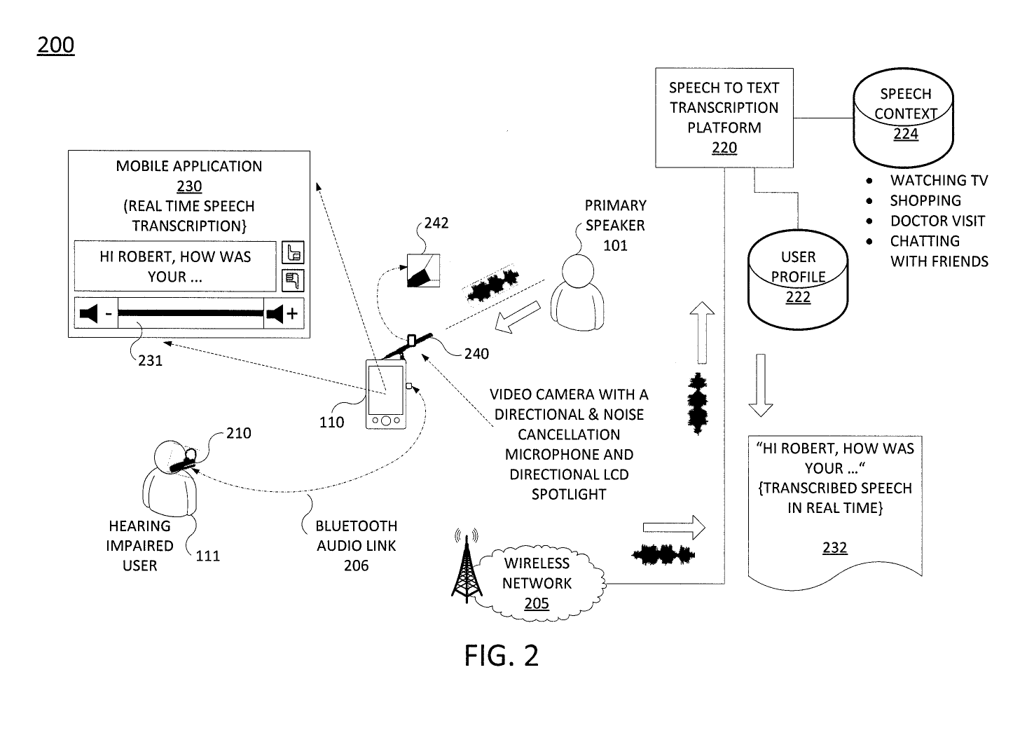

FIG. 2 illustrates a mobile multimodal speech hearing aid system 200. More specifically, the mobile multimodal speech hearing aid system 200 is a network-based and usage-based service that can operate through a mobile application 230, e.g., a smartphone application which can be installed on a mobile endpoint device 110, e.g., a smartphone, a cellular phone or a computing tablet. The audio and visual information from a primary speaker 101, e.g., a human speaker, facing the user 111 (e.g., a hearing impaired user) who is operating the mobile endpoint device 110 can be obtained using a built-in microphone and video camera on the mobile endpoint device. As smartphone becomes ubiquitous, a smartphone-based multimodal digital hearing aid service would allow the user with hearing impairments to engage a conversation with other people through a continuously-adjusted and personalized hearing enhancement service implemented as a multimodal speech hearing aid application on his or her smartphone.

In another embodiment, the hearing impaired user 111 can choose to deploy a separate audio-visual listening device 240 that can be connected to the mobile endpoint device using a multi-pin based connector. Namely, the external separate audio-visual listening device 240 may comprises a noise-cancellation microphone, a video camera and/or a directional light source. The external separate audio-visual listening device 240 may capture better audio inputs from the speaker 101. The video camera is used to capture video of the face of the speaker 101 while user 111 is facing the speaker 101. More specifically, the captured video is intended to capture the moving lips of the speaker 101. In one embodiment, the light source 242 can be a light emitting diode or a laser that is used to guide the video camera to trace the mouth movements when the primary speaker 101 is talking to the hearing impaired user 111.

In one embodiment, the video of the primary speaker generating the speech mainly consists of the primary speaker's face where the focus is on the mouth movements. This is often known as lip-reading by computer. From a pre-defined lip-reading video library, each mouth movement in hundredth of a second is stored in a still image. When the processor (e.g., a computer) receives such an image, the processor compares the image with a library of thousands of such still images associated with one or more phonemes and/or syllables that make up a word or phrase. Thus, the output of this “lip-reading” software on processing the video is a sequence of phonemes, which will be used to generate multiple alternatives of the words/phrases spoken by the primary speaker. This list of multiple texts is then used to confirm/correct the similar texts generated by ASR-enabled Speech-to-Text platform.

In operation, speech utterances from the primary speaker 101 are captured by the external microphone (or the build-in microphone within the smartphone) and streamed in real time by the mobile application on the smartphone to a network-based Speech-to-Text (STT) transcription platform or device 220, e.g., a network-based Speech-to-Text (STT) transcription module operating in AS 104 or any one or more application servers deployed in a distributed cloud environment. The speech utterances are recognized by the Automatic Speech Recognition (ASR) engine utilized by the STT platform.

In one embodiment, the ASR engine is dynamically configured with the speech recognition language models and contexts determined by a number of user specific profiles 222 and speech contexts 224. For example, a storage 224 contains a plurality of speech context models corresponding to various environments or scenarios such as: speaking to a medical professional, watching television, attending a class in a university, shopping in a department store, attending a political debate, speaking to a family member, speaking to a co-worker and so on. In practice, the user 111 will select one of a plurality of predefined speech context models when the mobile application is initiated. The STT will be able to perform more accurately if the proper predefined speech context model is used to assist in performing the speech to text translation. For example, utterances from a doctor in the context of a doctor visit may be quite different from utterances from a sales clerk in the context of shopping in a department store.

In one embodiment, user specific profiles are stored in the storage 222 or DB 106. The user specific profiles can be gathered over a period of time. For example, the hearing impaired user 111 may interact regularly with a group of known individuals, e.g., family members, co-workers, a family doctor, a new anchor on a television news program, and the like. The STT transcription platform may obtain recordings of these individuals and then over a period of time construct an audio signature for each of these individuals. In other words, similar to speech recognition software, the STT transcription platform may build a more accurate audio signature over time such that speech to text translation function can be made more accurate. Similar to the selection of a speech context model, the mobile software application allows the hearing impaired user 111 to identify the primary speaker, e.g., from a contact list on the mobile endpoint device. The contact list can be correlated with the user profiles stored in storage 222. For example, storage 222 may contain user profiles for the hearing impaired user's family members and co-workers. In fact, it has been shown that an initial user profile can be built using less than one minute of speech signal. Thus, when speaking to a stranger, the hearing impaired user 111 may select an option on the mobile application to record the utterance of a stranger for the purpose of creating a new user profile to be stored in storage 222.

Furthermore, by knowing the environment that the hearing impaired user 111 is currently located, e.g., at home, at work in an office, in a public place and so on, will assist the STT transcription platform. Specifically, the STT transcription platform can employ a different noise filtering algorithm for each different type of environment. In one example, the mobile application may select automatically the proper environment, e.g., based on the Global Positioning System (GPS) location of the smartphone.

In one embodiment, a 3-dimensional vector of data representing the mouth movements during the speech made by the primary speaker is also streamed from the mobile application to the STT platform and is utilized by the phoneme-based lip reading software module in the STT platform. These real-time phoneme sequences synchronized with the speech audio inputs (utterances) received by the ASR engine, will allow the automatic correction of potentially misrecognized words made by the ASR engine.

In one embodiment, the transcription of the speech to text signal 232 is then sent back to the mobile application 230 to be displayed on the smartphone. The user would compare what he or she has heard with the words that are displayed on the screen. When the words, phrases or sentences that the user heard match with the words that are displayed on the screen, the user may operate a tool bar 231, e.g., pressing a thumb-up icon to indicate to the mobile application to record the digital hearing aid parameters used at that time. Otherwise, the user can press a thumb-down icon to log the error events. Namely, the user did not hear the words that are being displayed on the screen.

In one embodiment, based on the real-time feedback, the mobile application may adjust the hearing aid parameters that are used to boost the speech audio received by the microphone of the hearing aid device 210 over a set of selected frequency bands. For example, this would cause the mobile application to dynamically boost certain frequency regions and/or attenuate other frequency regions. Thus, the processed audio signal is then in real time sent to hearing aid device 210, e.g., over Bluetooth-based audio link 206 so that the hearing impaired user can now listen to the dynamically enhanced speech in the voice of the primary speaker the user is listening to.

In one embodiment, the ASR-assisted and user-controlled dynamic adjustment/tuning of the hearing aid parameters are software based and automatically updated from time to time from a network-based service via a wireless network 205. Thus, the hearing impaired users are no longer required to pay a visit to a health care facility for a specialist to manually tune the hearing aid parameters in the digital hearing aid device.

In one embodiment, the present mobile multimodal speech hearing aid can be provided as a subscription service. For example, the user only has to pay for the service on a usage basis (e.g., 10 minutes, 30 minutes, and etc.)

In one embodiment, the user profile containing the hearing aid parameters is dynamically created and updated from each successful dialog between the hearing impaired user and the other party that the user is listening to. In other words, the hearing aid parameters can be dynamically and continuously updated and stored for each primary speaker.

In one embodiment, when there is a path of light between the hearing-impaired user and the primary speaker, the user can aim the external video camera 240 connected to the smartphone to the mouth of the speaker. This would increase the accuracy of the speech-to-text transcription on the SST platform by using the time-synchronized lip movement coordinates recorded by the video camera.

In one embodiment, the light source 242 may comprise a LCD-based beam light source for assisting the mobile application during in a lowlight condition.

In one embodiment, the user can create a new or ad hoc “environment” profile (e.g., in a doctor office where the user is a new patient) by carrying on a simple “chat” with a targeted primary speaker. After talking to the targeted primary speaker for a few minutes, the user can use the thumb-up and/or thump-down icons based on the presented text on the screen of the mobile endpoint device to adjust the initial system-preset hearing aid parameters.

In one embodiment, when the user and the primary speaker (e.g., attending a large conference or in an auditorium), the mobile application may provide a background noise reader feature. For example, the mobile application would listen to the background conversation and/or noise near the user and build automatically a digital audio filter. When the primary speaker starts to talk, the user can simply press an on-screen icon to activate the location-specific “noise-cancellation” filter while processing the speech audio generated by the primary speaker.

In one embodiment, for the persons whom the hearing impaired user talk to frequently face-to-face, the mobile application may use a video-based face recognition algorithm to identify the primary speaker. Once identified, the speech accent and vocabulary characteristics associated with the primary speaker are recorded and updated subsequently and uploaded to the SST platform as part of the user profile. Thus, the primary speaker's voice is optimized by choosing the most effective hearing aid parameters implemented in the mobile application. In addition, the acoustic models created from this specific primary speaker's speech are used in conjunction to the default speaker-independent acoustic models used by the ASR engine. The combined acoustic models would increase the speech recognition accuracy so that the real time speech transcription displayed on the application screen will become more accurate over time.

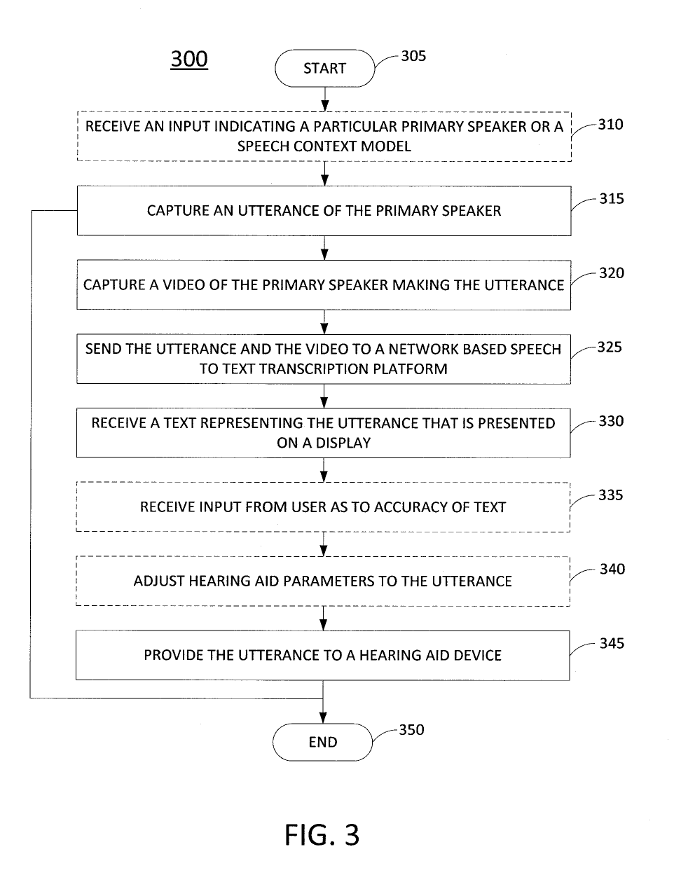

FIG. 3 illustrates a flowchart of a method 300 for providing mobile multimodal speech hearing aid. In one embodiment, the method 300 may be performed by the mobile endpoint device 110 or a general purpose computer as illustrated in FIG. 5 and discussed below.

The method 300 starts at step 305. At step 310 the method 300 optionally receives an input indicating a particular primary speaker (broadly a speaker) and/or a speech context model. For example, once the mobile application is activated, the user may indicate the identity of the primary speaker, e.g., from a contact list on the mobile endpoint device or a network based contact list. The user may also indicate the context in which the utterance of the primary speaker will need to be transcribed. Two types of context information can be conveyed, e.g., the type of activities (broadly activity context) such as speaking to a medical professional, watching television, attending a class in a university, shopping in a department store, attending a political debate, speaking to a family member, speaking to a co-worker, and the type of environment (broadly environment context) such as a doctor office, a work office, a home, a library, a classroom, a public area, an auditorium, and so on.

In step 315, the method 300 captures one or more utterance from the primary speaker. For example, external or internal microphone of the mobile endpoint device is used to capture the speech of the primary speaker.

In step 320, the method captures a video of the primary speaker making the one or more utterance. For example, external or internal camera of the mobile endpoint device is used to capture the video of the primary speaker making the utterance.

In step 325, the method 300 sends or transmits the utterance and the video wireless over a wireless network to a network based speech to text transcription platform, e.g., an application server implementing a network based speech to text transcription module or method.

In step 330, the method 300 receives a transcription of the utterance, e.g., text representing the utterance. The text representing the utterance is presented on a screen of the mobile endpoint device.

In step 335, method 300 optionally receives an input from the user as to the accuracy (broadly a degree of accuracy, e.g., “accurate” or “not accurate”) of the text representing the utterance. For example, the user may indicate whether the presented text matches the words heard by the user. In one embodiment, the input is received off line. In other words, the user may review the stored transcription at a later time and then highlight the mis-transcribed terms to indicate that those terms were not correct. The mobile endpoint device may provide an indication of the mis-transcribed terms to the STT platform. In one embodiment, the STT platform may present one or more alternative terms (the terms with the next highest computed probabilities) that can be used to replace the mis-transcribed terms.

In step 340, the method 300 may optionally adjust hearing aid parameters that will be applied to the utterance. For example, if the user indicates that the transcribed terms are not accurate, then one or more hearing aid parameters may need to be adjusted, e.g., certain audible frequencies may need to be amplified and/or certain audible frequencies may need to be attenuated.

In step 345, the method 300 provides the utterance to a hearing aid device, e.g., via a short-wavelength radio transmission protocol such as Bluetooth and the like. The utterance can be enhanced via the adjustments made in step 340 or not enhanced.

Method ends in step 350 or returns to step 315 to capture another utterance.

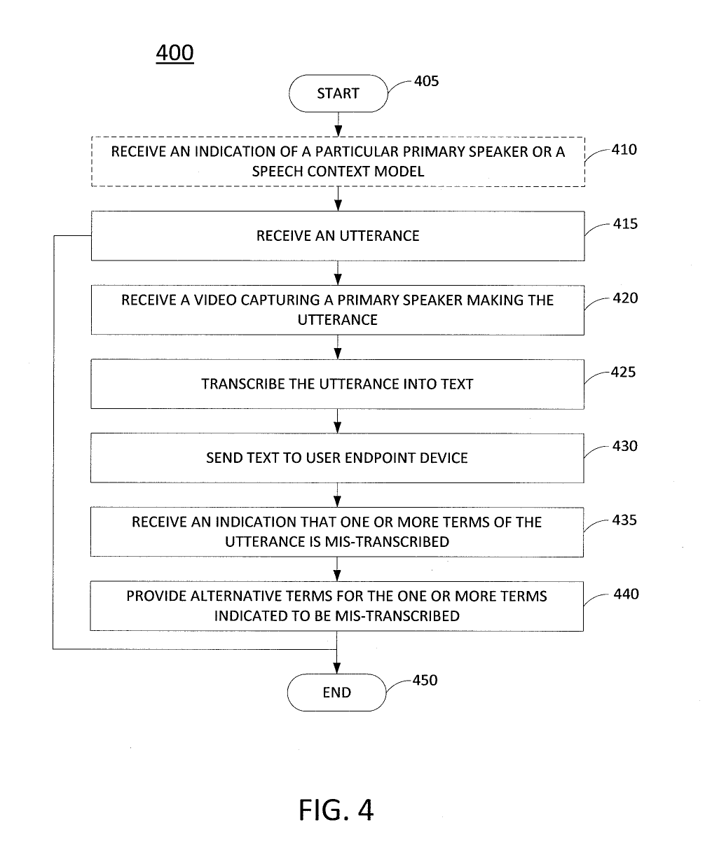

FIG. 4 illustrates a flowchart of a method 400 for providing mobile multimodal speech hearing aid. In one embodiment, the method 400 may be performed by the application server 104, the STT platform 220, or a general purpose computer as illustrated in FIG. 5 and discussed below.

The method 400 starts at step 405. At step 410 the method 400 optionally receives an indication from a mobile endpoint device indicating a particular primary speaker (broadly a speaker) and/or a speech context model should be used in transcribing upcoming utterances that will need to be transcribed. For example the user may indicate the identity of the primary speaker, e.g., from a contact list on the mobile endpoint device or a network based contact list to the STT platform. The user may also indicate the context in which the utterance of the primary speaker will need to be transcribed. Again two types of context information can be conveyed, e.g., the type of activities (broadly activity context) such as speaking to a medical professional, watching television, attending a class in a university, shopping in a department store, attending a political debate, speaking to a family member, speaking to a co-worker, and the type of environment (broadly environment context) such as a doctor office, a work office, a home, a library, a classroom, a public area, an auditorium, and so on.

In step 415, the method 400 receives one or more utterance associated with the primary speaker from the mobile endpoint device. For example, external or internal microphone of the mobile endpoint device is used to capture the speech of the primary speaker and then the captured speech is sent to the STT platform.

In step 420, the method 400 receives a video of the primary speaker making the one or more utterance. For example, external or internal camera of the mobile endpoint device is used to capture the video of the primary speaker making the utterance and then the video is sent to the STT platform.

In step 425, the method 400 transcribes the utterance using an automatic speech recognition algorithm or method. In one embodiment, the accuracy of the transcribed terms is verified using the video. For example, a lip reading algorithm or method is applied to the video. The text resulting from the video is compared to the text described from the utterance. For example, any uncertainty as to a term generated from the ASR can be resolved using terms obtained from the video.

In step 430, the method 400 sends a transcription of the utterance, e.g., text representing the utterance, back to the mobile endpoint device.

In step 435, method 400 optionally receives an indication from the mobile endpoint device as to the inaccuracy of one or more terms of the text representing the utterance. For example, the user may indicate whether the presented text matches the words heard by the user.

In step 440, the method 400 may optionally present one or more alternative terms (the terms with the next highest computed probabilities) that can be used to replace the mis-transcribed terms.

Method ends in step 450 or returns to step 415 to receive another utterance.

It should be noted that although not explicitly specified, one or more steps or operations of the methods 300 and 400 described above may include a storing, displaying and/or outputting step as required for a particular application. In other words, any data, records, fields, and/or intermediate results discussed in the methods can be stored, displayed, and/or outputted to another device as required for a particular application. Furthermore, steps, operations or blocks in FIGS. 3-4 that recite a determining operation, or involve a decision, do not necessarily require that both branches of the determining operation be practiced. In other words, one of the branches of the determining operation can be deemed as an optional step.

FIG. 5 depicts a high-level block diagram of a general-purpose computer suitable for use in performing the functions described herein. As depicted in FIG. 5, the system 500 comprises one or more hardware processor elements 502 (e.g., a central processing unit (CPU), a microprocessor, or a multi-core processor), a memory 504, e.g., random access memory (RAM) and/or read only memory (ROM), a module 505 for providing mobile multimodal speech hearing aid, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 505 for providing mobile multimodal speech hearing aid (e.g., a software program comprising computer-executable instructions) can be loaded into memory 504 and executed by hardware processor element 502 to implement the steps, functions or operations as discussed above in connection with the exemplary methods 300 and 400. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for providing mobile multimodal speech hearing aid (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for processing an utterance, comprising:
capturing, by a processor, the utterance made by a speaker;
capturing, by the processor, a video of the speaker making the utterance;
sending, by the processor, the utterance and the video to a speech to text transcription device;
receiving, by the processor, a text representing the utterance from the speech to text transcription device, wherein the text is presented on a screen of a mobile endpoint device; and
sending, by the processor, the utterance to a hearing aid device.

2. The method of claim 1, further comprising:
receiving, by the processor, an input indicating an identity of the speaker.

3. The method of claim 1, further comprising:
receiving, by the processor, an activity context in which the utterance was captured.

4. The method of claim 1, further comprising:
receiving, by the processor, an environment context in which the utterance was captured.

5. The method of claim 1, further comprising:
receiving, by the processor, an input indicating a degree of accuracy of the text that is received.

6. The method of claim 5, further comprising:
adjusting, by the processor, a hearing aid parameter based on the input indicating the degree of accuracy of the text that is received.

7. The method of claim 6, wherein the sending of the utterance to the hearing aid device comprises applying the hearing aid parameter that is adjusted to the utterance prior to sending the utterance to the hearing aid device.

8. The method of claim 5, wherein when the degree of accuracy indicates the text that is received is mis-transcribed, sending an indication to the speech to text transcription device that a term of the text is mis-transcribed.

9. The method of claim 8, further comprising:
receiving, by the processor, an alternative term for the term of the text that is mis-transcribed.

10. The method of claim 1, wherein the sending of the utterance and the video comprises transmitting the utterance and the video over a wireless network to the speech to text transcription device.

11. The method of claim 10, wherein the wireless network comprises a cellular network.

12. The method of claim 10, wherein the wireless network comprises a wireless-fidelity network.

13. An apparatus for processing an utterance, comprising:
a processor of a sender device; and
a computer-readable storage device storing a plurality of instructions which, when executed by the processor, cause the processor to perform operations, the operations comprising:
capturing the utterance made by a speaker;
capturing a video of the speaker making the utterance;
sending the utterance and the video to a speech to text transcription device;
receiving a text representing the utterance from the speech to text transcription device, wherein the text is presented on a screen of a mobile endpoint device; and
sending the utterance to a hearing aid device.

14. The apparatus of claim 13, the operation further comprising:
receiving an input indicating an identity of the speaker.

15. The apparatus of claim 13, the operations further comprising:
receiving an activity context in which the utterance was captured.

16. The apparatus of claim 13, the operations further comprising:
receiving an environment context in which the utterance was captured.

17. The apparatus of claim 13, the operations further comprising:
receiving an input indicating a degree of accuracy of the text that is received.

18. The apparatus of claim 17, the operations further comprising:
adjusting a hearing aid parameter based on the input indicating the degree of accuracy of the text that is received.

19. The apparatus of claim 18, wherein the sending of the utterance to the hearing aid device comprises applying the hearing aid parameter that is adjusted to the utterance prior to sending the utterance to the hearing aid device.

20. A method for processing an utterance, comprising:
receiving, by a processor, the utterance made by a speaker from a mobile endpoint device;
receiving, by the processor, a video of the speaker making the utterance from the mobile endpoint device;
transcribing, by the processor, the utterance into a text representing the utterance, wherein the video is used to confirm an accuracy of the text;
sending, by the processor, the text representing the utterance to the mobile endpoint device, where the text is to be displayed;
receiving, by the processor, an indication that a term of the text is mis-transcribed; and
sending, by the processor, an alternative term for the term of the text that is mis-transcribed.
